(19) United States
(12) Patent Application Publication
(10) Pub. No.: US 2013/0175223 A1
(43) Pub. Date: Jul. 11, 2013

(54) Remediation of Slurry Ponds

(71) Applicants: David C. Rennard, Houston, TX (US); Justin D. Pace, Houston, TX (US); Thomas R. Palmer, Calgary (CA)

(72) Inventors: David C. Rennard, Houston, TX (US); Justin D. Pace, Houston, TX (US); Thomas R. Palmer, Calgary (CA)

(21) Appl. No.: 13/720,960

(22) Filed: Dec. 19, 2012

Related U.S. Application Data
(60) Provisional application No. 61/583,923, filed on Jan. 6, 2012.

(51) Int. Cl. C02F 11/12

(52) U.S. Cl. CPC C02F 11/121
USPC 210/710; 210/170.09; 210/170.05

(57) ABSTRACT

System and methods for remediating a slurry pond are disclosed herein. A method includes distributing a material over a surface of the slurry pond, wherein the slurry pond includes residues from a plant operation. A method also includes placing a load on the material, wherein the load causes the material to sink below a level of a supernatant but to remain above a layer of sludge in the slurry pond.

### CROSS-REFERENCE TO RELATED APPLICATION

This application claims the priority benefit of U.S. Provisional Patent Application 61/583,923 filed Jan. 6, 2012 entitled REMEDIATION OF SLURRY PONDS, the entirety of which is incorporated by reference herein.

### FIELD

The present techniques provide for the remediation of slurry ponds through dewatering. More specifically, the techniques provide for dewatering residues using a geotextile.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Mining operations typically utilize an extraction process that results in a product and a waste stream. The waste stream is often referred to as “tailings.” When a liquid is included within the extraction process, this can result in fluid tailings that are to be stored in suitable enclosures. In the case of oil sands mining, these tailings form tailings ponds in which fine particles settle over a period of several years to form a stable suspension of 30 weight percent (wt %) solids in water. This suspension is known as mature fine tailings (MFT). The accumulation of MFT on a massive scale has resulted in legislation in Alberta, Canada to form trafficable tailings deposits, i.e., to dewater tailings and ultimately allow reclamation activities upon mine closure.

At present, there are several techniques for dewatering tailings, but they have relatively high costs. These high costs are driven by materials handling issues, technology operating issues, and capital costs, as well as the cost of setting aside Designated Disposal Areas (DDA) of the mine site for tailings dewatering activities. Mining operations that produce plentiful fluid tailings may involve the dedication of an area of land of significant surface area to DDAs. This can sterilize ore or pose higher costs for extraction due to subsequent materials handling.

Currently, the leading technologies for dewatering tailings include a composite tailings (CT) process, a centrifuge process, a thickened tailings process, and an in-line flocculation process. The CT process works by combining mature fine tailings (MFT) and sand with a coagulant to form a non-segregating mixture. Tailings are often flocculated to form thickened tailings, instead of mature fine tailings, and then used in the production of composite tailings. In either case, the mixture is placed in a deposition cell and allowed to dewater over time. Unfortunately, composite tailings are sensitive to shear, which causes sand to separate from fines, resulting in “off-spec composite tailings.” Because off-spec composite tailings dewater very slowly, off-spec composite tailings are stored in tailings ponds. Because of the addition of sand, the volume of composite tailings is often much greater than the volume of the original MFT, resulting in higher storage costs for off-spec composite tailings that dewater slowly.

The CT process fails when desegregation of the sand and fines occurs. Such desegregation may cause the fines to float to the top as the sand sinks to the bottom. The CT process succeeds when the sand stays within the viscous fines fluid and adds extra weight to the fluid, inducing dewatering and consolidation. When the sand sinks through the fluid, consolidation of the fines cannot be further induced by the effective stress of the sand load.

Centrifuges are commercially available devices that dewater tailings based on density differences. Rotation causes centripetal force, which induces higher density material to move to the edges, while lower density material, e.g., water, moves to the middle. This separation enables the densification of tailings. Often, centrifugation is combined with a flocculent treatment to make the solids more readily separable. Centrifuges have high operating and capital costs, and do not scale well for deployment in large applications. As a result, many centrifuges may be used for a particular application, resulting in high capital and maintenance expenses.

The thickened tailings process is becoming more common in mining applications. A thickener is a conically-shaped vessel in which tailings are allowed to settle and compact. The thickener compaction zone enables dewatering to occur, but the rates of compaction are often balanced with the degree of compaction and the ability to continue to flow. Thickeners usually make use of flocculation, and often have a rake to provide shear of the consolidating zone. The rake shears the zone to enhance dewatering. Thickeners are often enormous vessels, which contributes to their capital costs. The need for flocculants for treatment also contributes to high operating costs. Furthermore, the limitation of having to move material from the bottom of the thickener limits their application for final dewatering processes.

The in-line flocculation process involves passing tailings through a pipe. While they flow, the tailings are contacted with a flocculant. This flocculant mixes with the tailings in the pipe. Thus, the inflow to the pipe can be untreated tailings, while the outflow is flocculated tailings. This technology often involves higher dosing of flocculant than thickeners, but has the advantage of not requiring a large vessel. Thus, this technology typically has high operating costs and low capital costs.

The above technologies are often coupled with a strategy for deposition of the tailings. Tailings can be deposited in thick lifts, e.g., those that are on the order of about 3-10 meters. If tailings behave like a fluid rather than a solid, thick lifts are contained within a structure, such as a dam, dyke, or toe system. One strategy for enhancing drainage in thick lift deposition involves the application of dug trenches around the perimeter of the deposit, while another strategy involves installing wick drains.

Thin lift deposition is another option. However, thin lifts, e.g., those that are less than about 1 m, use large tracks of land in order to distribute tailings on dry ground, so that the tailings may dewater before the next lift is deposited. Tailings can be deposited above the water table to enable dewatering by atmospheric drying, drainage, and consolidation, or below the water table, which leverages consolidation but not atmospheric drying.

### SUMMARY

An exemplary embodiment provides a method for remediating a slurry pond. The method includes distributing a material over a surface of the slurry pond, wherein the slurry pond includes residues from a plant operation. The method also includes placing a load on the material, wherein the load causes the material to sink below a level of a supernatant but to remain above a layer of sludge in the slurry pond.

Another exemplary embodiment provides a slurry dewatering system. The slurry dewatering system includes a slurry pond containing a suspended solid, a material covering the surface of the slurry pond, and a load covering the material. The load applies an effective stress on an underlying layer of sludge.

Another exemplary embodiment provides a method for dewatering tailings within a tailings pond. The method includes placing tailings in a first tailings pond to form a layer of sludge and a first layer of water. The method also includes placing a geotextile and a load over the tailings, wherein the load causes the geotextile to sink below the first layer of water but remain above the layer of sludge. The method further includes removing a portion of the first layer of water from the first tailings pond and replacing the portion of the first layer of water with a second layer of water or additional tailings, or any combination thereof.

### DESCRIPTION OF THE DRAWINGS

The advantages of the present techniques are better understood by referring to the following detailed description and the attached drawings, in which:

FIG. 1 is a drawing of a development illustrating the use of surface mining to harvest hydrocarbons from a reservoir;

FIG. 2 is a process flow diagram of a method for reclaiming a slurry pond;

FIG. 3A is a schematic of a tailings pond with a geotextile spread over its surface;

FIG. 3B is a schematic of the tailings pond with a load applied on top of the geotextile;

FIG. 3C is a schematic of the tailings pond after the tailings have been dewatered;

FIG. 4 is a schematic of the tailings pond with flocculated tailings placed over the tailings within the tailings pond;

FIG. 5A is a schematic of the tailings pond during a decanting process for removing the supernatant;

FIG. 5B is a schematic of the tailings pond after the supernatant has been removed;

FIG. 5C is a schematic of the tailings pond during a refilling procedure for distributing additional tailings on top of the load within the tailings pond;

FIG. 5D is a schematic of the tailings pond during a refilling procedure for pouring fresh water on top of the load within the tailings pond;

FIG. 6A is a schematic of a tailings pond that is divided into cells using a fold of geotextile;

FIG. 6B is a schematic of a tailings pond that is divided into cells using geotubes; and

FIG. 7 is a process flow diagram of a method for dewatering tailings within a tailings pond, decanting the water from the tailings pond, and refilling the tailings pond.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Bitumen” is a naturally occurring heavy oil material. It is often the hydrocarbon component found in oil sands. Bitumen can vary in composition depending upon the degree of loss of more volatile components. It can vary from a viscous, tar-like, semi-solid material to a solid material. The hydrocarbon types found in bitumen can include aliphatics, aromatics, resins, and asphaltenes. A typical bitumen might be composed of:

19 wt. % aliphatics, which can range from 5 wt. %-30 wt. %, or higher;

19 wt. % asphaltenes, which can range from 5 wt. %-30 wt. %, or higher;

30 wt. % aromatics, which can range from 15 wt. %-50 wt. %, or higher;

32 wt. % resins, which can range from 15 wt. %-50 wt. %, or higher; and

some amount of sulfur, which can range in excess of 7 wt. %.

In addition bitumen can contain some water and nitrogen compounds ranging from less than 0.4 wt. % to in excess of 0.7 wt. %. The metals content, while small, can be removed to avoid contamination of the product. Nickel can vary from less than 75 ppm (part per million) to more than 200 ppm. Vanadium can range from less than 200 ppm to more than 500 ppm. The percentage of the hydrocarbon types found in bitumen can vary.

A “development” is a project for the recovery of hydrocarbons using integrated surface facilities and long-term planning. The development can be directed to a single hydrocarbon reservoir, although multiple proximate reservoirs may be included.

As used herein, “exemplary” means “serving as an example, instance, or illustration.” Any embodiment described herein as “exemplary” is not to be construed as preferred or advantageous over other embodiments.

As used herein, a “facility,” or “plant,” is a collection of physical equipment through which hydrocarbons and other fluids may be either produced from a reservoir or injected into a reservoir. A facility may also include equipment which can be used to control production or completion operations. In its broadest sense, the term facility is applied to any equipment that may be present along the flow path between a reservoir and its delivery outlets. Facilities may include production wells, injection wells, well tubulars, wellhead equipment, gathering lines, manifolds, pumps, compressors, separators, surface flow lines, steam generation plants, extraction plants, processing plants, water treatment plants, and delivery outlets. In some instances, the term “surface facility” is used to distinguish those facilities other than wells.

“Heavy oil” includes oils which are classified by the American Petroleum Institute (API) as heavy oils or extra heavy oils. In general, heavy oil has an API gravity between 22.3° (density of 920 kg/m³ or 0.920 g/cm³) and 10.0° (density of 1,000 kg/m³ or 1 g/cm³), or less than 10.0° in some cases. Further, heavy oil with an API gravity of less than 10.0° (density greater than 1,000 kg/m³ or greater than 1 g/cm³) may be termed “extra heavy oil.” For example, a source of heavy oil includes oil sand or bituminous sand, which is a combination of clay, sand, water, and bitumen. The thermal recovery of heavy oils is based on the viscosity decrease of fluids with increasing temperature or solvent concentration. Once the viscosity is reduced, the mobilization of fluids by steam, hot water flooding, or gravity is possible. The reduced viscosity makes the drainage quicker and, therefore, directly contributes to the recovery rate.

A “hydrocarbon” is an organic compound that primarily includes the elements hydrogen and carbon, although nitrogen, sulfur, oxygen, metals, or any number of other elements may be present in small amounts. As used herein, hydrocarbons are used to refer to components found in bitumen, or other oil sands.

As used herein, a “reservoir” is a subsurface rock or sand formation from which a production fluid can be harvested. The rock formation may include sand, granite, silica, carbonates, clays, and organic matter, such as oil, gas, or coal, among others. Reservoirs can vary in thickness from less than one foot (0.3048 m) to hundreds of feet (hundreds of m).

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

“Tailings” are a waste material generated or obtained in the course of extracting the valuable material, e.g., bitumen, from the non-valuable material, e.g., sand, slurry, or sludge, in extraction operations. “Oil sand fine tailings” are tailings derived from oil sands extraction operations. Such tailings include mature fine tailings (MFT) from tailings ponds and fine tailings from ongoing extraction operations that may bypass a tailings pond, among others. “Flotation tailings” are the waste stream produced from a flotation cell. These tailings are often placed in a holding cell called a tailings pond. After 1-2 years, these tailings will settle to a stable suspension of MFT.

“Sludge,” or “tailings sludge,” is the portion of sand or other solids that does not settle out but, instead, remain in suspension in the aqueous phase during a bitumen recovery process. A typical analysis of the tailings sludge from a commercial scale plant is nominally 25% solids, e.g., 3% bitumen and 22% other solids, and 75% water. The solids include various constituents, including silica, zircon, mica, kaolinite, montmorillonite, illite and chlorite. The amount of each of these solid constituents varies. However, kaolinite generally constitutes about 50% or more of the total solids. As a result of the inability to obtain effective liquid-solids separation through natural settling action, the problem of tailings disposal becomes progressively more acute as more and more sands are processed, since the aqueous sludge accumulates in direct proportion to the amount of sands processed. Disposal of the tailings presents an environmental challenge. Many solutions to this problem have been proposed, including the use of flocculation, filtration, hydrocyclones and centrifuges, or distillation and freeze-thaw methods, among others.

“Flocculation” is a process wherein colloids are brought out of suspension in the form of “floc” or “flakes” through the addition of a clarifying agent. Flocculation may result in the aggregation of small particles into larger particles.

“Geotextiles,” or “geofabrics,” are permeable materials that may be used for filtration, separation, or drainage purposes. Geotextiles are typically made from polypropylene or polyester, and may be woven or non-woven. “Geotubes” are tubes or containers that are formed using geotextiles. “Wick drains” are tubes with a semi permeable wall. Wick drains often have a plastic substructure that creates a passage for water to move along the long axis of the wick drain.

### Overview

Embodiments described herein provide for the remediation of a slurry pond through dewatering. In some embodiments, for example, the methods and system described herein may relate to the dewatering of tailings from the production of oil from oil sands within a tailings pond. The dewatering of the tailings may be accomplished by placing a geotextile over the tailings pond and applying a load, such as sand, on top of the material in order to force the water out of the underlying tailings. Such a method of dewatering tailings within a tailings settling pond provides for flexibility in mine planning because the remediation can occur in pre-existing ponds, requiring a much smaller mine footprint. It is to be understood that, while the embodiments disclosed herein are often discussed in the context of tailings deposited in tailings ponds, the methods and system disclosed herein may be similarly applied to any types of slurries deposited in slurry ponds, such as mine tailings, ash ponds at coal fired power plants, and the like.

According to embodiments disclosed herein, introducing a geotextile between the fluid tailings and the sand prevents the sand from becoming distributed as individual grains. As a result, the sand may evenly apply an effective stress to the underlying fluid tailings. Whether the fluid tailings can penetrate up through the sand depends on the particle size distributions, the size of the pores in the geotextile, and the viscosity and permeability of the fluid. Flocculation may also be used to increase the viscosity of the liquid, making it more difficult for the flocculated tailings to penetrate a small diameter pore. Water, however, may be allowed seep out of the tailings and navigate up through the pores in the geotextile.

The dewatering of tailings often occurs through a variety of mechanisms, including evaporation, drainage, and consolidation. For example, thick lift deposition is the placement of tailings in containment structures such as dykes or toes dams. The tailings are typically placed at depths on the order of 3-10 m. Thick lift deposition takes advantage of consolidation as an increase in stress causes underlying tailings to dewater. Thick lift deposition effectively shuts down evaporation, except at the surface.

Drainage and consolidation are dependent on the hydraulic conductivity of the material to be dewatered, as well as the materials that occupy the pathway through which the water would migrate. In other words, even a highly permeable surface will resist dewatering if it is coated with an impermeable shell. Evaporation is often used for drying. However, when a lift of tailings reaches a high solids concentration, i.e., around 50% to 60% solids, the soils are densified by consolidation rather than evaporation. In other words, a load is placed on top of the soils to compress them. Drying by evaporation or freeze-thaw can occur on the surface of a lift, but the depth of penetration is limited. For this reason, tailings are often dried in thin lifts.

Final capping strategies are commonly implemented above the water table, and tailings are generally dewatered prior to the implementation of such capping strategies. In order for conventional equipment to distribute a geotextile over a deposit and place a load on top of the geotextile, it is first determined that the deposits have a suitable shear strength. For example, the sheer strength of low strength muds may be increased using specialized equipment, such as amphiboles, or seasonal considerations, such as waiting for winter to freeze the tailings deep enough to hold conventional equipment, e.g., trucks. The final loading applies an effective stress that enables consolidation of the soil to final volumes, which is required for the land to achieve full settlement.

Wet sand has a greater hydraulic conductivity than dry sand. This indicates that a wet sand cap can consolidate faster than a dry sand cap, since water within the underlying deposit can escape through the sand faster if the sand is wet rather than dry. Furthermore, sand is ineffective at applying an effective stress if the sand falls through the underlying material. Instead, the particles simply rearrange themselves, and the fluid tailings move on top of the sand.

Geotextiles are often used for mining applications, as well as for geotechnical stabilization of landforms. The use of geotextiles in oil sands processes was demonstrated by Suncor (Wells, Caldwell, and Fournier, “Suncor Pond 5 Coke Cap—The story of its conception, testing, and advance to full-scale construction,” Tailings and Mine Waste 2010 Conference Proceedings, 2010). According to Suncor, geotextiles were used for floating a coke cap above composite tailings. Geotextiles were also used at Suncor (E. Olauson, Ibid, 393) for capping soft tailings to enhance strength almost immediately prior to reclamation. In neither instance, however, was a geotextile spread from a barge and sunk onto a subaqueous layer. Furthermore, geotextiles are placed on somewhat consolidated tailings that include high quantities of sand, such as more than equal parts sand and fines, i.e., where fines are less than 44 microns. Such tailings also have higher densities (>1.6) and higher solids concentrations (>45%).

Geotextiles are also routinely applied in subaqueous environments, such as, for example, in lakes, bays, and rivers, as a tool in the engineering of soil mechanics and civil engineering. Examples are given by Bell and Tracy, “St. Luis River/Interlake/Duluth Tar Site Remediation, Sediment Operable Unit—2006 Sand Cap/Surcharge Project,” WODCON Conference, 2007. According to such examples, contaminated soils or soft soils are dredged, placed to a minor depth, capped with a geotextile, and then capped with sand.

However, in this case, the contaminated soils or soft soils have not been previously treated with a hydrocarbon extraction process. Further, the contaminated soils or soft soils contain no bitumen and are consolidating soils. In contrast, the oil sands fine tailings or other slurries that are utilized according to system and methods described herein form stable suspensions that behave like fluids and include mostly fine particles. The tools of soil mechanics are not applied because of the fluid nature of the tailings. Hydrostatic charging separates individual clays within the suspension, rather than grain-to-grain contact, as is typical in most soil mechanics applications.

### Surface Mining Recovery Process

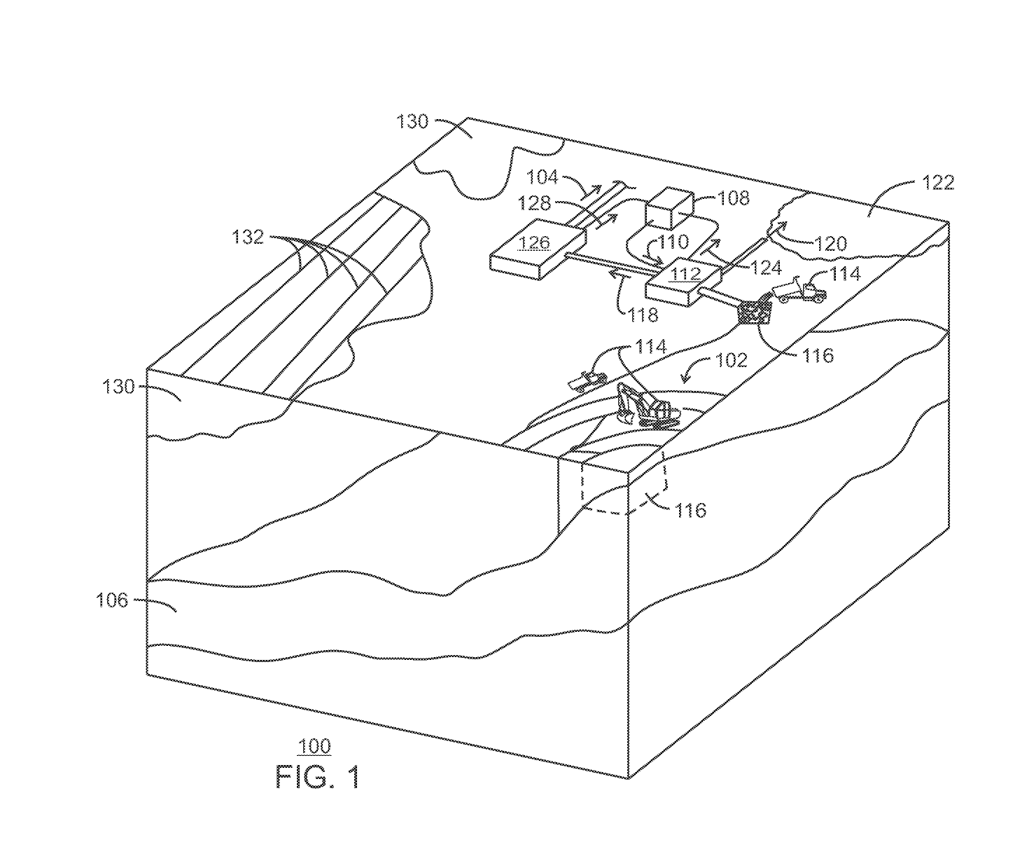

FIG. 1 is a drawing of a development 100 illustrating the use of surface mining 102 to harvest hydrocarbons 104 from a reservoir 106. It will be clear that the techniques described herein are not limited to this combination, or these specific techniques, as any number of techniques or combinations of techniques may be used in embodiments described herein. In the development 100, a steam generation facility 108 is used to generate steam 110, which can be provided to a surface separation facility 112.

The surface mining 102 uses heavy equipment 114 to remove hydrocarbon containing materials 116, such as oil sands, from the reservoir 106. The hydrocarbon containing materials 116 are offloaded at the separation facility 112, where a thermal process, such as a Clark hot water extraction (CHWE), among others, may be used to separate a hydrocarbon stream 118 from a tailings stream 120. The tailings stream 120 may be sent to a tailings pond 122, or may be injected into a sub-surface formation for disposal. A water stream 124 may be recycled to the steam generation facility 108.

The hydrocarbon stream 118 may be sent to a transportation facility 126, which may provide further separation and purification of the incoming hydrocarbon stream 118, prior to sending the marketable hydrocarbons 104 on to further processing facilities. The resulting process water 128 can be returned to the steam generation facility 108 for recycling.

The development 100 may also include a number of previously-filled tailings ponds 130. The previously-filled tailings ponds 130 may contain tailings streams that were previously produced from a separation facility, such as the separation facility 112. In various embodiments, the previously-filled tailings ponds 130 may be covered with sheets of geotextiles 132. The sheets of geotextiles 132 may be used to dewater the tailings streams within the previously-filled tailings ponds 130. For example, a load, such as sand, may be applied on top of the sheets of geotextiles 132 in order to force the supernatant, e.g., water, to move above the sheets of geotextiles 132. In another example, the geotextile has a density between the densities of the slurry and the supernatant, so that the geotextile settles on its own onto the slurry.

### Reclamation of Slurry Ponds

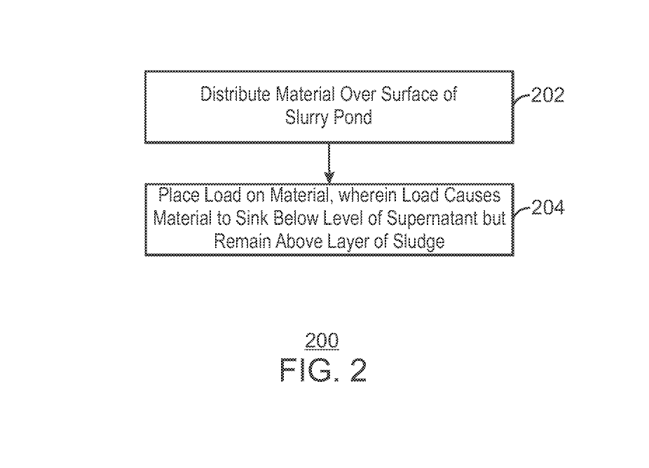

FIG. 2 is a process flow diagram of a method 200 for reclaiming a slurry pond. The slurry pond may be a sewage remediation pond, a fly ash impoundment dam, a tailings pond, a waste water treatment pond, a cement processing waste pond, an agricultural waste pond, or a food processing waste pond, among others. The slurry pond includes residues from a plant operation, wherein the residues include suspended solids.

The method 200 begins at block 202 with the distribution of a material over the surface of the slurry pond. The material may be, for example, a geotextile, such as a non-woven geofabric. The material may also be a number of geotubes. In various embodiments, the material may include a number of small holes, or pores, through which particles of a certain diameter may penetrate. Further, different types of materials may be chosen based on the desired permeability for each application of the method 200. For example, nonwoven, polypropylene, staple fiber, needlepunched geotextiles may be used. In addition, woven polypropylene geotextiles containing heavy woven tape or fibrillated fabric may be used. In some embodiments, the geotextile may have three-dimensional characteristics, such as prongs or surface roughness that enable it to cling to itself.

In some embodiments, the material is distributed over the surface of the slurry pond using a barge. For example, a barge may be used to lay overlapping sheets of geotextile across the slurry pond. In addition, a mechanism may be used to control the flotation of the material on the surface of the slurry pond. The mechanism may include, for example, a diaphragm, weighted buoys, or floats, among others. The mechanism may also include the selection of a material with a density that causes the material to be at the interface between the layer of sludge and the level of supernatant.

At block 204, a load is placed on the material. The load causes the material to sink below a level of supernatant and apply a stress on the underlying sludge. The load and geofabric do not pass straight through the sludge. The supernatant may be water, while the sludge may be, for example, tailings from a production of oil from oil sands. In various embodiments, the load may be sand, residues from a plant operation, such as tailings from the production of oil from oil sands, or any other type of load material that has a desired level of permeability. Further, in some embodiments, the load material may also be an impermeable material, such as scrap metal. In such cases, a fluid flow path may be incorporated within the load material using, for example, a wick drain in order to allow the supernatant to move above or into the load material.

In some embodiments, the layer of sludge within the slurry pond is separated into multiple cells in order to allow for the dewatering of individual sections of the slurry pond. The cells may be divided by geotextiles, geomembranes, sand, or geotubes filled with the mixture from the slurry pond, among others.

In various embodiments, the method 200 may be used for the dewatering of tailings from the production of oil from oil sands within a tailings pond, as discussed above. The dewatering of the tailings may be used to produce sludge that is over 50 weight percent (wt %) solids derived from thickened tailings, treated tailings, treated mature fine tailings, or composite tailings, among other. The load placed over the material may be sand, treated tailings, mature fine tailings, treated mature fine tailings, or composite tailings, among others. In some embodiments, at least a portion of a topmost supernatant layer is removed from the tailings pond. The tailings pond may include at least two meters of water, a first layer of tailings, the material, and a first load. A second layer of tailings may be placed on top of the first load to form a second load, wherein the load further increases a stress on the first layer of tailings. The second layer of tailings may then be dewatered by, for example, depositing the second layer of tailings in thin layers. The first layer of tailings and the second layer of tailings may include mature fine tailings, treated flotation tailings, treated mature fine tailings, or composite tailings, among others.

In some embodiments, the treated flotation tailings and the treated mature fine tailings are dewatered by decanting released water to a drain or a pond. A wick drain may also be placed with one end within the first layer of tailings and the other end within the second layer of tailings in order to facilitate the dewatering process. Further, in some embodiments, flocculated tailings may be placed on top of the tailings in the tailings pond prior to the distribution of the material over the surface of the tailings pond in order to facilitate the dewatering process. In some embodiments, a chemical coagulant may also be placed on top of the tailings in tailings pond prior the distribution of the material.

### Examples

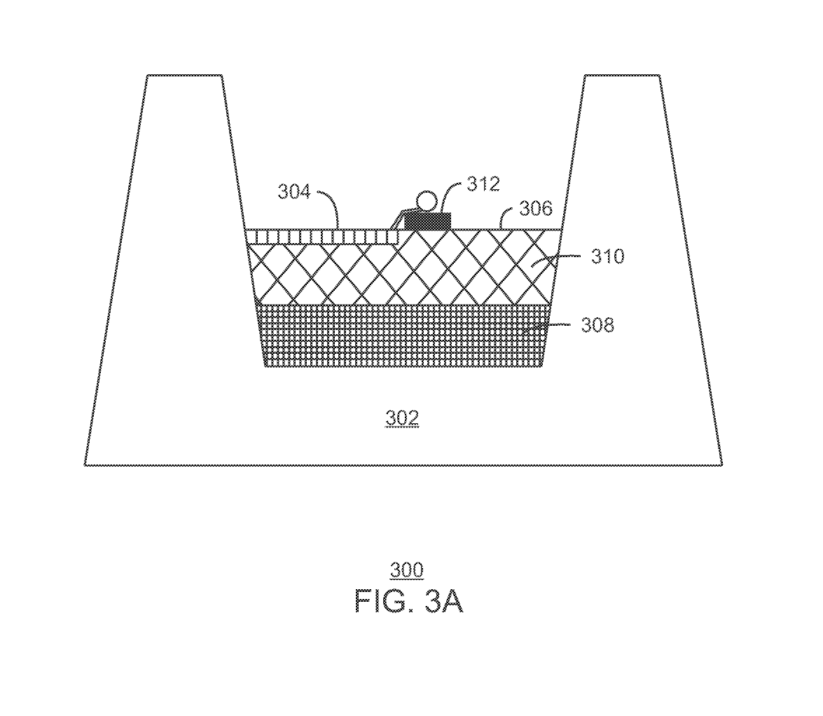

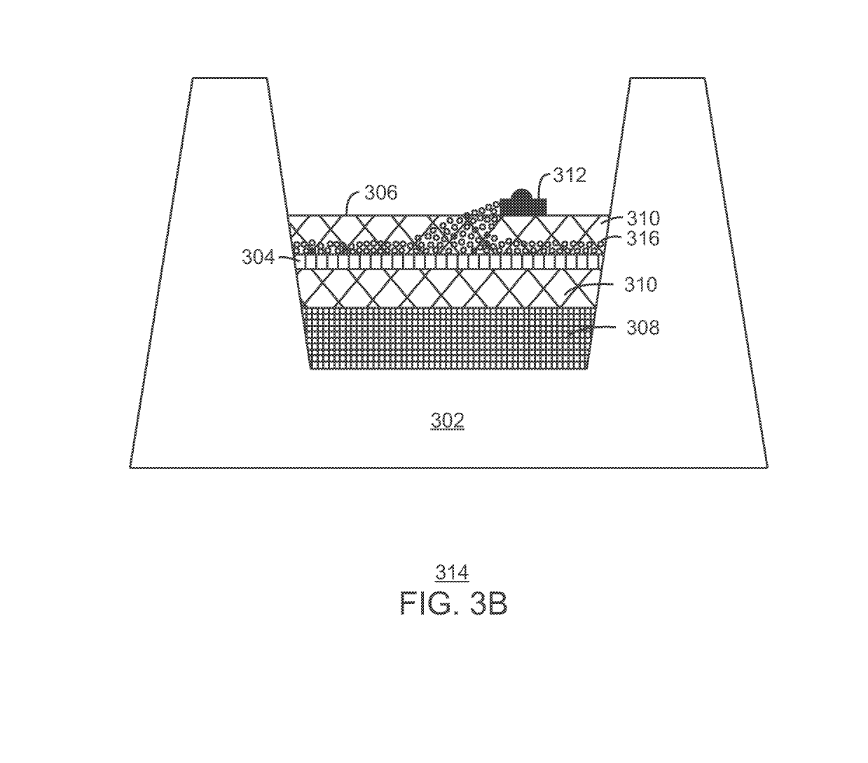

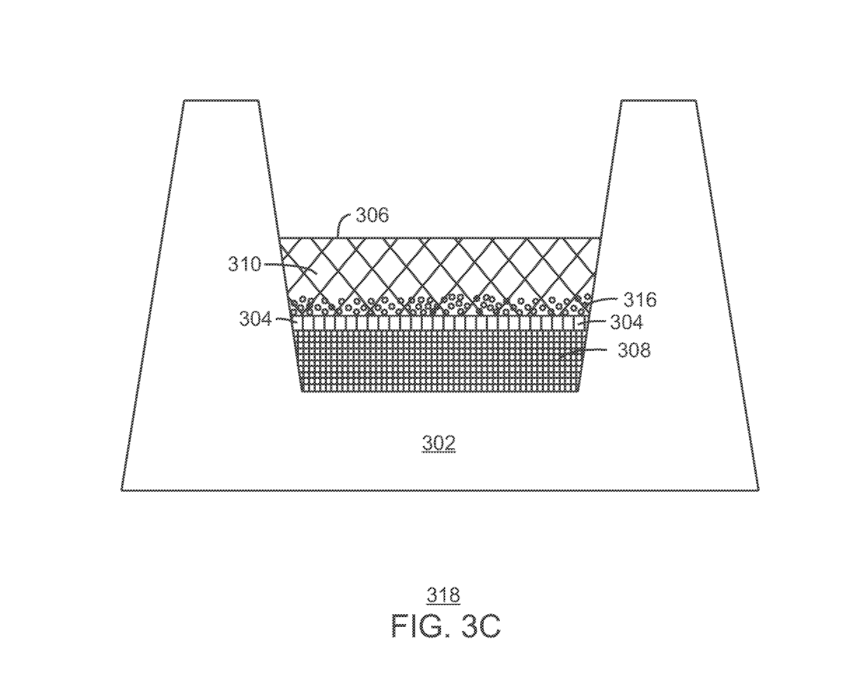

FIG. 3A is a schematic 300 of a tailings pond 302 with a geotextile 304 spread over its surface 306. The tailings pond 302 may include a layer of tailings 308, as well as a layer of supernatant 310. The tailings 308 may be, for example, mature fine tailings, while the supernatant 310 may be water. A barge 312 may be used to distribute the geotextile 304 over the surface 306 of the tailings pond 302, as discussed above. The barge 312 may distribute individual sheets or strips of the geotextile 304 over the surface 306 of the tailings pond 302, for example, as shown in FIG. 1. The individual sheets or strips may be laid over the tailings pond 302, starting at one end and moving towards the other end. The individual sheets of the geotextile 304 may be distributed such that they overlap with one another to a degree that provides a tight seal that may not be easily penetrated by the supernatant 310.

FIG. 3B is a schematic 314 of the tailings pond 302 with a load 316 applied on top of the geotextile 304. In some embodiments, the load 316 may be sand that is distributed over the geotextile 304 using the barge 312, as shown in FIG. 3B. The load 316 may also be treated tailings, mature fine tailings, treated mature fine tailings, or composite tailings, among others. In some embodiments, the load 316 is distributed across the geotextile 304 using a sprayer, split hull vessel, or other similar equipment. The load 316 may cause a portion of the layer of supernatant 310 to rise above the geotextile 304, resulting in the dewatering of the underlying tailings 308.

FIG. 3C is a schematic 318 of the tailings pond 302 after the tailings 308 have been dewatered. As shown in FIG. 3C, once the dewatering process is complete, a large portion of the layer of supernatant 310 may be above the geotextile 304, while the tailings 308 may remain below the geotextile 304. This may be accomplished by utilizing a geotextile with pores that are not large enough to enable the penetration of the tailings 308.

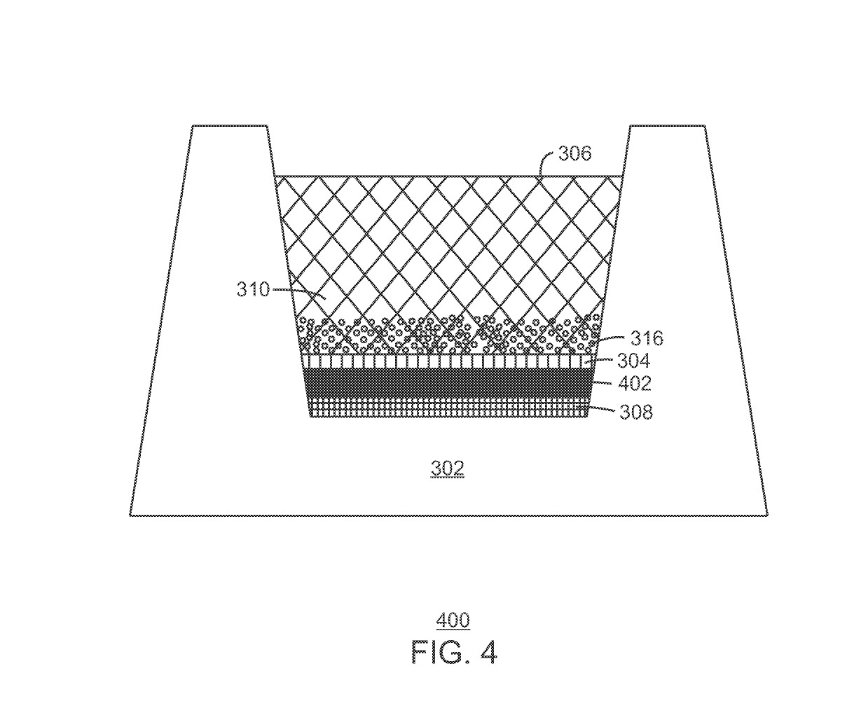

FIG. 4 is a schematic 400 of the tailings pond 302 with flocculated tailings 402 placed over the tailings 308 within the tailings pond 302. Like numbered items are as described with respect to FIG. 3. The flocculated tailings 402 may be placed over the tailings 308 within the tailings pond 302 prior to the distribution of the geotextile 304 over the surface 306 of the tailings pond 302. The flocculated tailings 402 may aid in the dewatering process by reducing the risk of the blinding of the geotextile 304 by fines contained within the tailings 308. In other words, the flocculated tailings 402 may act as a filter for the underlying tailings 308. In some embodiments, a chemical coagulant may also be used in the same manner as described above with respect to flocculated tailings.

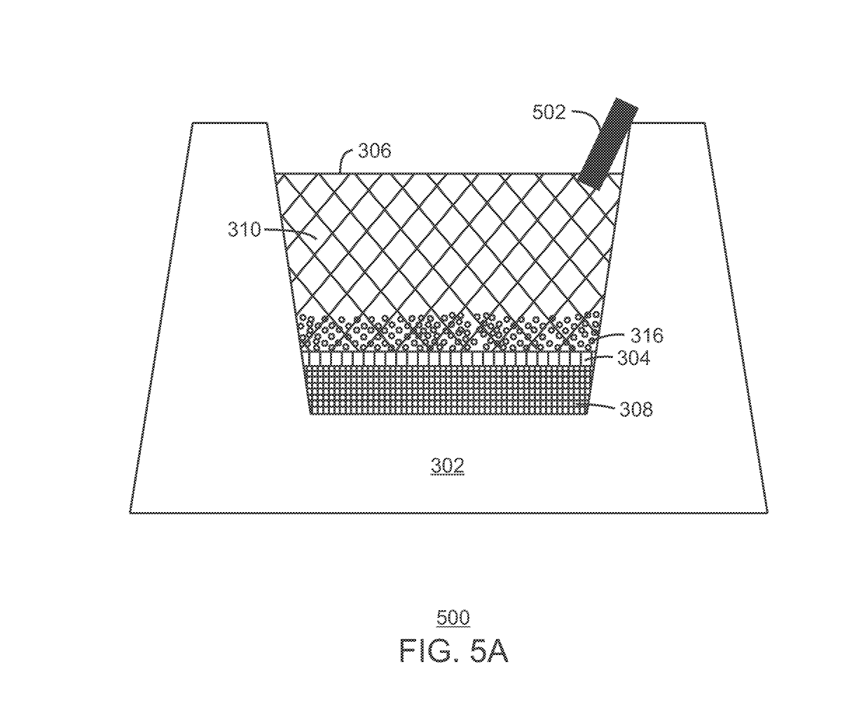

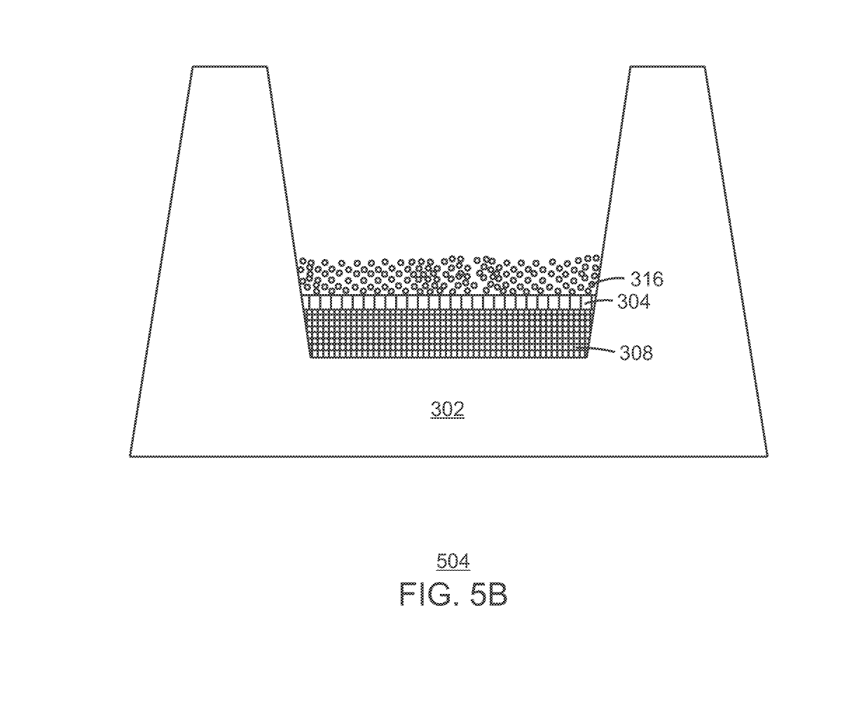

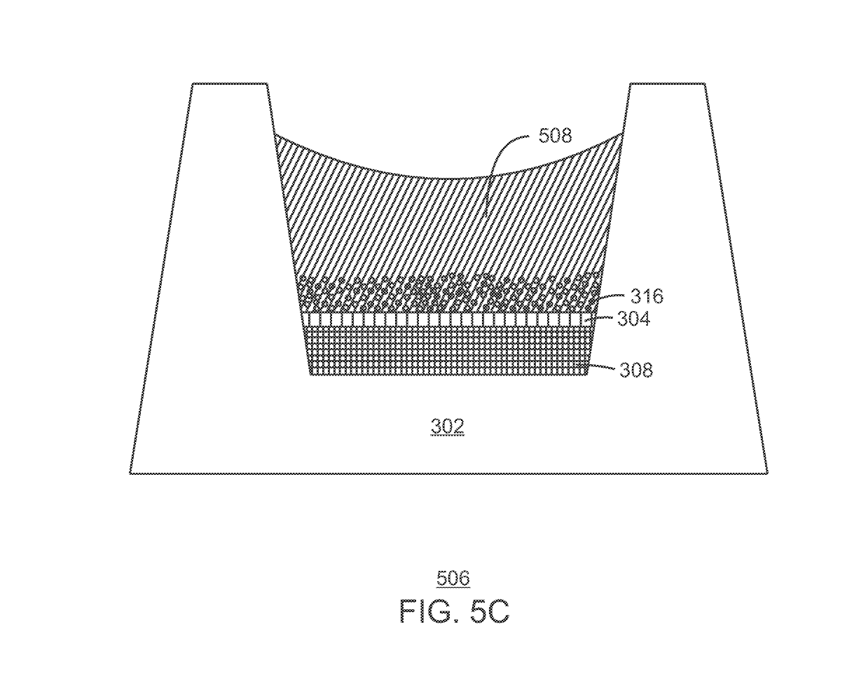

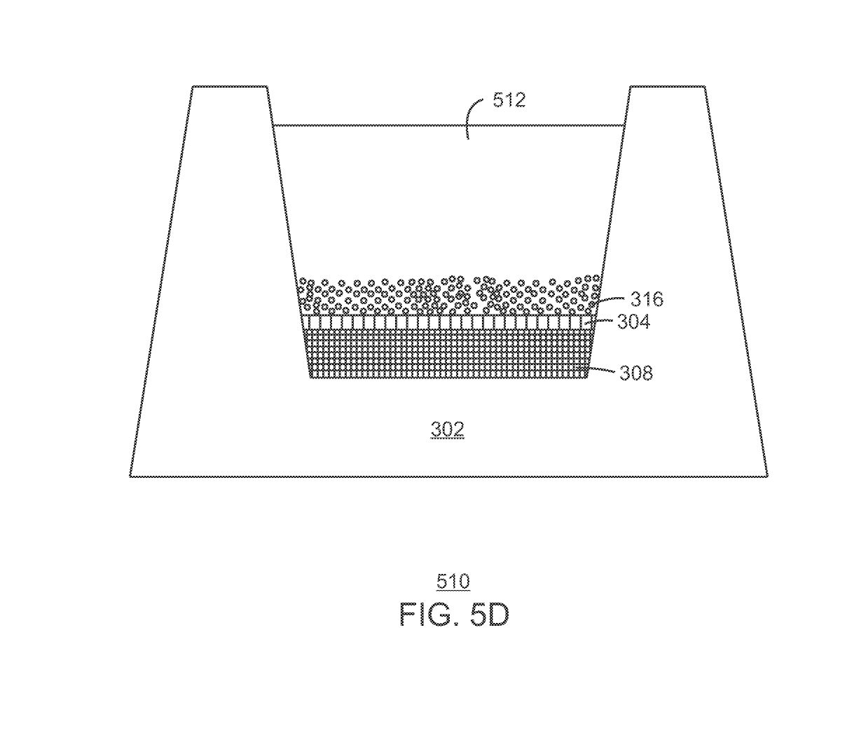

FIG. 5A is a schematic 500 of the tailings pond 302 during a decanting process for removing the supernatant 310. Like numbered items are as described with respect to FIGS. 3 and 4. In various embodiments, a decanting pipe 502 may be used to remove the supernatant 310 from the tailings pond 302. Further, in some embodiments, the supernatant 310 may be placed in a second tailings pond, and sludge from the second tailings pond may be added to the tailings pond 302.

FIG. 5B is a schematic 504 of the tailings pond 302 after the supernatant 310 has been removed. Once the supernatant 310 has been removed, the load 316 may become a “false bottom” that is not sufficient for immediate reclamation. In some embodiments, an amount of the load 316 may be increased by pouring or spraying additional sand or tailings, for example, over the geotextile 304. This may accelerate the consolidation of the underlying tailings 308.

FIG. 5C is a schematic 506 of the tailings pond 302 during a refilling procedure for distributing additional tailings 508 on top of the load 316 within the tailings pond 302. The additional tailings 508 may aid in the consolidation of the underlying tailings 308 by acting as an additional load. Further, the additional tailings 508 may be distributed within the tailings pond 302 in order to provide more space to the mine site by storing several layers of tailings within one tailings pond.

FIG. 5D is a schematic 510 of the tailings pond 302 during a refilling procedure for pouring fresh water 512 on top of the load 316 within the tailings pond 302. Like numbered items are as described with respect to FIGS. 3 and 4. In some embodiments, the addition of the fresh water 512 to the first tailings pond 302 forms an end-pit lake. The sludge consolidation at the bottom of the end-pit lake may reach a shear strength of 10 kPa within 25 years, wherein the sludge consolidation is an indication of the shear strength of the soil. For example, at a sludge consolidation that achieves an undrained shear strength of 10 kPa, the sludge within the tailings pond 302 may behave as a semi-solid or solid.

The fresh water 512 may have different water chemistry than the supernatant 310 (FIG. 5A). In some embodiments, a water treatment plant may be used to treat the decanted supernatant 310 to create the fresh water 512. The fresh water 512 can be used to generate biota within the tailings pond 302, while the underlying tailings 308 are effectively sequestered by the geotextile 304 and the load 316.

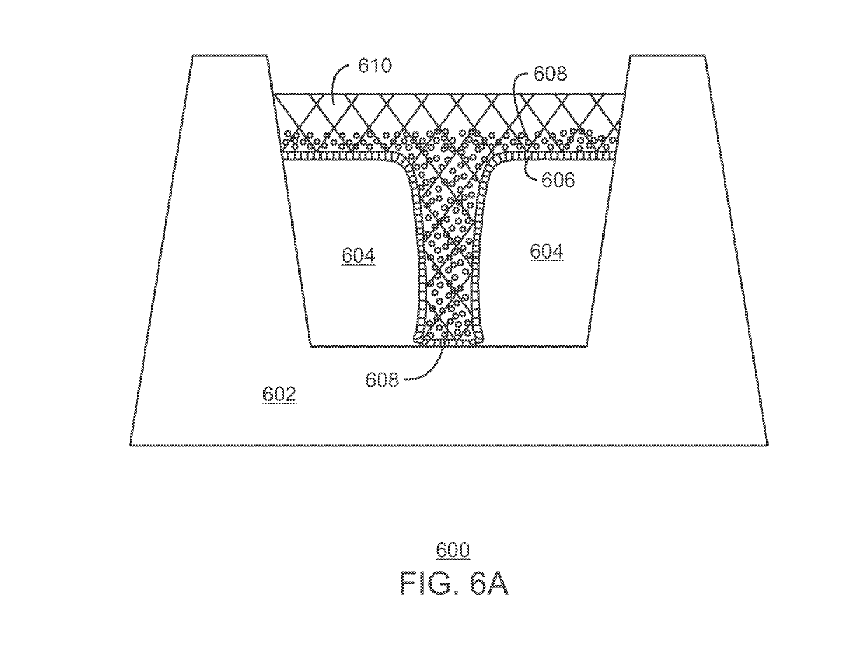

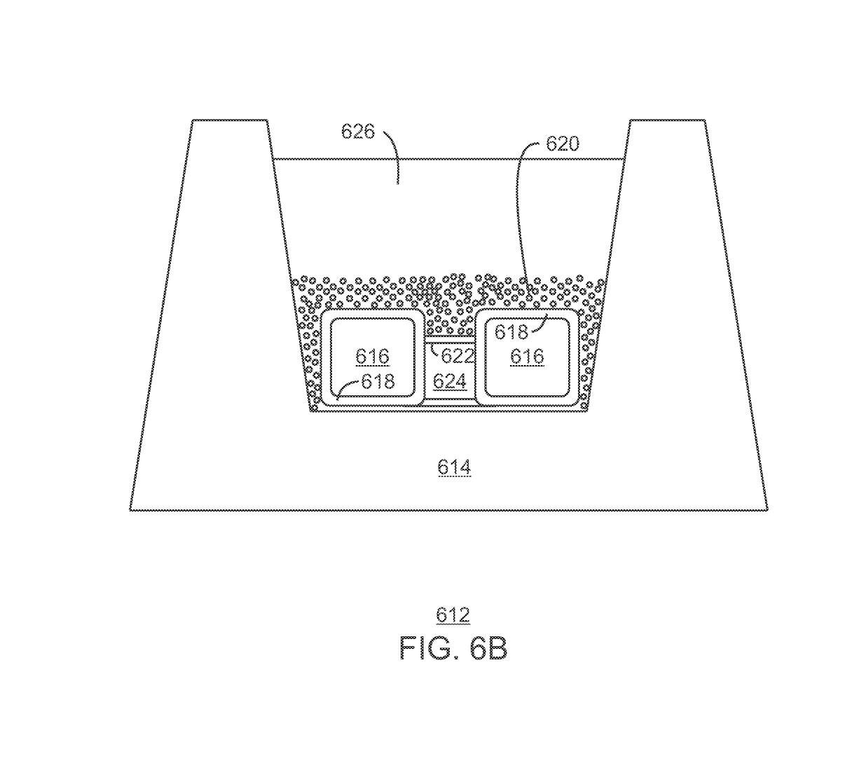

FIG. 6A is a schematic 600 of a tailings pond 602 that is divided into cells 604 using a fold of geotextile 606. A column of sand 608 may be used to separate the cells 604 and to apply a load to the top of each of the cells 604. The division of the tailings pond 602 into several individual cells 604 facilitates the dewatering of the tailings within the cells 604 by inhibiting the migration of the underlying tailings when the sand 608 or other load is placed on top of the geotextile 606. Supernatant 610 may pass out of the cells 604 through the geotextile 606 and the sand 608, forming a level of supernatant 610 above the layer of sand 608.

FIG. 6B is a schematic 612 of a tailings pond 614 that is divided into cells 616 using geotubes 618. The cells 616 within the geotubes 618 are generally filled with the slurry, such as the mature fine tailings. In addition, sand 620 may be distributed on top of the cells 616 in order to facilitate the dewatering of the tailings within the cells 616. In some embodiments, the geotubes 618 are attached to one another through geotextiles 622, allowing for the creation of additional cells 624 between the cells 616. Supernatant 626 may pass out of the cells 616 and 624 through the geotubes 618 and the geotextile 622, respectively, and the sand 620, forming a level of supernatant 626 above the layer of sand 620.

### Remediation of Tailings Ponds

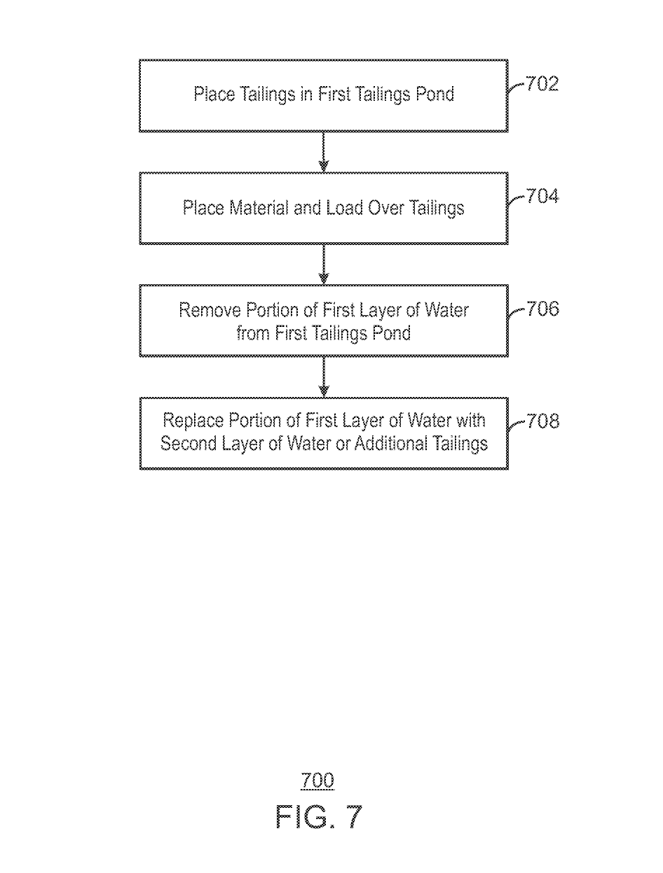

FIG. 7 is a process flow diagram of a method 700 for dewatering tailings within a tailings pond, decanting the water from the tailings pond, and refilling the tailings pond. The dewatering of the tailings may allow for the remediation of the tailings pond. In various embodiments, the fluid tailings within the tailings pond may be treated as unconsolidated soil, enabling capping strategies to be implemented at less than 40% solids concentrations. In some embodiments, the tailings are MFT, flotation tailings, or fresh fluid tailings produced in a plant, placed in a pond, or run off of a deposit. Further, in various embodiments, the tailings can be treated in any of a number of ways prior to the beginning of the method 700, including, for instance, thickening or in-line flocculation. The flocculation of the tailings may occur in a pipe or in conjunction with a thickening process or centrifuge process. The tailings may then be placed in a location suitable for the application of a load.

The method begins at block 702 with the placement of tailings in a first tailings pond. The tailings may include tailings from the production of oil from oil sands. It is to be understood that, in some embodiments, the tailings may have been placed in the first tailings pond a number of years prior to the start of the method 700. Further, the tailings within the first tailings pond may include a number of different types of tailings from various plant operations that were placed within the first tailings pond throughout a span of several years.

At block 704, a material may be placed over the tailings, and a load may be placed on top of the material. The material may be, for example, a geotextile, such as a non-woven geofabric or geomembrane. The load may include sand, treated tailings, mature fine tailings, treated mature fine tailings, or composite tailings, among others. The material or the load may be distributed over the surface of the first tailings pond using any type of suitable equipment, such as, for example, a barge. In various embodiments, the application of the load may cause water to seep through holes or pores within the material, forming a layer of water at the surface of the first tailings pond.

At block 706, a portion of the first layer of water may be removed from the first tailings pond. A decanter or any other type of suitable equipment may be used to remove the water. The removal of the first layer of water may cause the load to become a “false bottom” that is not sufficient for immediate reclamation. In some embodiments, an additional load may be applied on top of the load in order to facilitate the further dewatering of the underlying tailings.

At block 708, the portion of the first layer of water may be replaced with a second layer of water or additional tailings, or any combination thereof. In some embodiments, the additional tailings may aid in the consolidation of the underlying tailings by acting as an additional load. In other embodiments, the addition of the second layer of water may be used to generate biota, since the underlying tailings are effectively sequestered by the material and the load.

In some embodiments, the second layer of water may have different water chemistry than the first layer of water. The second layer of water may be created from the first layer of water within a water treatment plant. The addition of the second layer of water to the first tailings pond may result in the formation of an end-pit lake. The sludge consolidation at the bottom of the end-pit lake may achieve a shear strength of 10 kPa within 25 years. In various embodiments, the first layer of water may be placed in a second tailings pond, and sludge from the second tailings pond may be added to the first tailings pond.

### Embodiments

Embodiments of the invention may include any combinations of the methods and systems shown in the following numbered paragraphs. This is not to be considered a complete listing of all possible embodiments, as any number of variations can be envisioned from the description above.

1. A method for remediating a slurry pond, comprising:
distributing a material over a surface of the slurry pond, wherein the slurry pond includes residues from a plant operation; and
placing a load on the material, wherein the load causes the material to sink below a level of a supernatant but to remain above a layer of sludge in the slurry pond.

2. The method of paragraph 1, wherein the slurry pond includes a sewage remediation pond, a fly ash impoundment dam, a tailings pond, a waste water treatment pond, a cement processing waste pond, an agricultural waste pond, a landfill runoff pond, a food processing waste pond, a mine tailings pond, or a body of water with an accumulation of sediments, or any combinations thereof.

3. The method of any of paragraphs 1 or 2, wherein the material includes a geotextile or geotubes, or any combination thereof.

4. The method of any of paragraphs 1, 2, or 3, wherein placing the load on the material includes distributing sand on top of the material.

5. The method of any of the preceding paragraphs, wherein distributing the material over the surface of the slurry pond includes using a barge to distribute the material.

6. The method of any of the preceding paragraphs, comprising using a mechanism to control a flotation of the material, wherein the mechanism includes a diaphragm, weighted buoys, floats, or a selection of a density of the material that causes the material to be at an interface between the layer of sludge and the level of supernatant, or any combinations thereof.

7. The method of any of the preceding paragraphs, comprising:
distributing a material over a surface of a tailings pond, wherein the tailings pond includes tailings from a production of oil from oil sands; and
placing a load on the material, wherein the load causes the material to sink below a level of a supernatant but to remain above a layer of sludge.

8. The method of paragraph 7, wherein placing the load on the material includes placing sand, treated tailings, mature fine tailings, treated mature fine tailings, or composite tailings, or any combinations thereof, on the material.

9. The method of any of paragraphs 7 or 8, comprising:
removing at least part of a topmost supernatant layer from the tailings pond, wherein the tailings pond includes at least two meters of water, a first layer of tailings, the material, and a first load;
placing a second layer of tailings on top of the first load to form a second load, wherein the second load increases a stress on the first layer of tailings; and
dewatering the second layer of tailings.

10. The method of paragraph 9, wherein the first layer of tailings and the second layer of tailings include mature fine tailings, treated flotation tailings, treated mature fine tailings, or composite tailings.

11. The method of paragraph 10, comprising dewatering the first layer of tailings or the second layer of tailings, or any combination thereof, by decanting released water to a drain or a pond.

12. The method of any of paragraphs 9 or 10, comprising dewatering the second layer of tailings by depositing the second layer of tailings in thin layers.

13. The method of any of paragraphs 9, 10, or 11, comprising placing an end of a wick drain within the first layer of tailings and placing another end of the wick drain above the second layer of tailings.

14. The method of any of paragraphs 7, 8, or 9, comprising placing flocculated tailings or a chemical coagulant, or any combination thereof, on top of the tailings in the tailings pond prior to distributing the material over the surface of the tailings pond.

15. A slurry dewatering system, comprising:
a slurry pond comprising a suspended solid;
a material covering a surface of the slurry pond; and
a load covering the material, wherein the load applies an effective stress on an underlying layer of sludge.

16. The system of paragraph 15, wherein the slurry pond includes a sewage remediation pond, a fly ash impoundment dam, a tailings pond, a waste water treatment pond, a cement processing waste pond, an agricultural waste pond, a landfill runoff pond, a food processing waste pond, a mine tailings pond, or a body of water with an accumulation of sediments, or any combinations thereof.

17. The system of any of paragraphs 15 or 16, wherein the material includes a geotextile.

18. The system of any of paragraphs 15, 16, or 17, wherein the effective stress causes the material to sink below a level of a supernatant, and wherein the supernatant includes water.

19. The system of any of paragraphs 15-18, wherein a barge is used to distribute the material over the surface of the slurry pond.

20. The system of any of paragraphs 15-19, wherein a wick drain is placed with an end within the sludge and another end within the supernatant.

21. The system of any of paragraphs 15-20, wherein a mechanism is used to control a flotation of the material, and wherein the mechanism includes a diaphragm, weighted buoys, floats, or a selection of a density of the material that causes the material to be at an interface between the underlying layer of sludge and a level of a supernatant, or any combinations thereof.

22. The system of paragraph 21, wherein the mechanism is used to control a flotation of the material in a supernatant or in the underlying layer of sludge.

23. The system of any of paragraphs 15-21, wherein the underlying layer of sludge is separated into cells.

24. The system of any of paragraphs 15-21 or 23, wherein the cells are divided by geotextiles, geotubes, geomembranes, sand, or geotubes filled with a weight, or any combinations thereof.

25. The system of any of paragraphs 15-21, 23, or 24, comprising:
a tailings pond comprising tailings;
a material covering a surface of the tailings pond; and
a load covering the material, wherein the load causes the material to sink below a level of a supernatant and applies an effective stress to a layer of sludge.
26. The system of paragraph 25, wherein the load includes sand, treated tailings, mature fine tailings, treated mature fine tailings, or composite tailings, or any combinations thereof.

27. The system of any of paragraphs 25 or 26, wherein the sludge includes over fifty weight percent thickened tailings, treated tailings, flocculated tailings, or mature fine tailings.

28. The system of any of paragraphs 25, 26, or 27, wherein the load is a property of a density of the material.

29. A method for dewatering tailings within a tailings pond, comprising:
placing tailings in a first tailings pond to form a layer of sludge and a first layer of water;
placing a geotextile and a load over the tailings, wherein the load causes the geotextile to sink below the first layer of water but remain above the layer of sludge;
removing a portion of the first layer of water from the first tailings pond; and
replacing the portion of the first layer of water with a second layer of water or additional tailings, or any combination thereof.

30. The method of paragraph 29, wherein the first layer of water includes different water chemistry than the second layer of water.

31. The method of any of paragraphs 29 or 30, wherein a water treatment plant is used to treat the first layer of water to create the second layer of water.

32. The method of any of paragraphs 29, 30, or 31, wherein an addition of the second layer of water to the first tailings pond forms an end-pit lake, and wherein a sludge consolidation at a bottom of the end-pit lake achieves 10 kPa undrained shear strength within 25 years.

33. The method of any of paragraphs 29-32, wherein the first layer of water is placed in a second tailings pond, and wherein sludge from the second tailings pond is added to the first tailings pond.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A method for remediating a slurry pond, comprising:
distributing a material over a surface of the slurry pond, wherein the slurry pond comprises residues from a plant operation; and
placing a load on the material, wherein the load causes the material to sink below a level of a supernatant but to remain above a layer of sludge in the slurry pond.

2. The method of claim 1, wherein the slurry pond comprises a sewage remediation pond, a fly ash impoundment dam, a tailings pond, a waste water treatment pond, a cement processing waste pond, an agricultural waste pond, a landfill runoff pond, a food processing waste pond, a mine tailings pond, or a body of water with an accumulation of sediments, or any combinations thereof.

3. The method of claim 1, wherein the material comprises a geotextile or geotubes, or any combination thereof.

4. The method of claim 1, wherein placing the load on the material comprises distributing sand on top of the material.

5. The method of claim 1, wherein distributing the material over the surface of the slurry pond comprises using a barge to distribute the material.

6. The method of claim 1, comprising using a mechanism to control a flotation of the material, wherein the mechanism comprises a diaphragm, weighted buoys, floats, or a selection of a density of the material that causes the material to be at an interface between the layer of sludge and the level of supernatant, or any combinations thereof.

7. The method of claim 1, comprising:
distributing a material over a surface of a tailings pond, wherein the tailings pond comprises tailings from a production of oil from oil sands; and
placing a load on the material, wherein the load causes the material to sink below a level of a supernatant but to remain above a layer of sludge.

8. The method of claim 7, wherein placing the load on the material comprises placing sand, treated tailings, mature fine tailings, treated mature fine tailings, or composite tailings, or any combinations thereof, on the material.

9. The method of claim 7, comprising:
removing at least part of a topmost supernatant layer from the tailings pond, wherein the tailings pond comprises at least two meters of water, a first layer of tailings, the material, and a first load;
placing a second layer of tailings on top of the first load to form a second load, wherein the second load increases a stress on the first layer of tailings; and
dewatering the second layer of tailings.

10. The method of claim 9, wherein the first layer of tailings and the second layer of tailings comprise mature fine tailings, treated flotation tailings, treated mature fine tailings, or composite tailings, or any combinations thereof.

11. The method of claim 10, comprising dewatering the first layer of tailings or the second layer of tailings, or any combination thereof, by decanting released water to a drain or a pond.

12. The method of claim 9, comprising dewatering the second layer of tailings by depositing the second layer of tailings in thin layers.

13. The method of claim 9, comprising placing an end of a wick drain within the first layer of tailings and placing another end of the wick drain above the second layer of tailings.

14. The method of claim 7, comprising placing flocculated tailings or a chemical coagulant, or any combination thereof, on top of the tailings in the tailings pond prior to distributing the material over the surface of the tailings pond.

15. A slurry dewatering system, comprising:
a slurry pond comprising a suspended solid;
a material covering a surface of the slurry pond; and
a load covering the material, wherein the load applies an effective stress on an underlying layer of sludge.

16. The system of claim 15, wherein the slurry pond comprises a sewage remediation pond, a fly ash impoundment dam, a tailings pond, a waste water treatment pond, a cement processing waste pond, an agricultural waste pond, a landfill runoff pond, a food processing waste pond, a mine tailings pond, or a body of water with an accumulation of sediments, or any combinations thereof.

17. The system of claim 15, wherein the material comprises a geotextile.

18. The system of claim 15, wherein the effective stress causes the material to sink below a level of a supernatant, and wherein the supernatant comprises water.

19. The system of claim 15, wherein a barge is used to distribute the material over the surface of the slurry pond.

20. The system of claim 15, wherein a wick drain is placed with an end within the underlying layer of sludge and another end within a level of a supernatant.

21. The system of claim 15, wherein a mechanism is used to control a flotation of the material, and wherein the mechanism comprises a diaphragm, weighted buoys, floats, or a selection of a density of the material that causes the material to be at an interface between the underlying layer of sludge and a level of a supernatant, or any combinations thereof.

22. The system of claim 21, wherein the mechanism is used to control a flotation of the material in a supernatant or in the underlying layer of sludge.

23. The system of claim 15, wherein the underlying layer of sludge is separated into cells.

24. The system of claim 23, wherein the cells are divided by geotextiles, geotubes, geomembranes, sand, or geotubes filled with a weight, or any combinations thereof.

25. The system of claim 15, comprising:
a tailings pond comprising tailings;
a material covering a surface of the tailings pond; and
a load covering the material, wherein the load causes the material to sink below a level of a supernatant and applies an effective stress to a layer of sludge.

26. The system of claim 25, wherein the load comprises sand, treated tailings, mature fine tailings, treated mature fine tailings, or composite tailings, or any combinations thereof.

27. The system of claim 25, wherein the sludge comprises over fifty weight percent thickened tailings, treated tailings, flocculated tailings, or mature fine tailings.

28. The system of claim 25, wherein the load is a property of a density of the material.

29. A method for dewatering tailings within a tailings pond, comprising:
placing tailings in a first tailings pond to form a layer of sludge and a first layer of water;
placing a geotextile and a load over the tailings, wherein the load causes the geotextile to sink below the first layer of water but remain above the layer of sludge;
removing a portion of the first layer of water from the first tailings pond; and
replacing the portion of the first layer of water with a second layer of water or additional tailings, or any combination thereof.

30. The method of claim 29, wherein the first layer of water comprises different water chemistry than the second layer of water.

31. The method of claim 29, wherein a water treatment plant is used to treat the first layer of water to create the second layer of water.

32. The method of claim 29, wherein an addition of the second layer of water to the first tailings pond forms an end-pit lake, and wherein a sludge consolidation at a bottom of the end-pit lake achieves 10 kPa undrained shear strength within 25 years.

33. The method of claim 29, wherein the first layer of water is placed in a second tailings pond, and wherein sludge from the second tailings pond is added to the first tailings pond.
